(19) United States
(12) Patent Application Publication
(10) Pub. No.: US 2026/0241720 A1
(43) Pub. Date: Aug. 20, 2026

(54) IMAGE FORMING APPARATUS

(71) Applicant: CANON KABUSHIKI KAISHA, Tokyo (JP)

(72) Inventors: YUTA ARAKI, Kanagawa (JP); KAZUKI MATSUO, Tokyo (JP)

(21) Appl. No.: 19/544,095

(22) Filed: Feb. 19, 2026

(30) Foreign Application Priority Data
Feb. 20, 2025 (JP) 2025-026025
Nov. 28, 2025 (JP) 2025-209599

(51) Int. Cl. B41J 13/10; B41J 3/44; B41J 3/60; B41J 29/13; H04N 1/00

(52) U.S. Cl. CPC B41J 13/106; B41J 3/44; B41J 3/60; B41J 13/103; B41J 29/13; H04N 1/00557; H04N 1/00591

(57) ABSTRACT

There is provided with an image forming apparatus. A sheet conveyance unit conveys a sheet in a conveyance direction from a front surface side of a housing toward a rear surface side. An image forming unit forms an image on the sheet in the conveyance direction in the sheet conveyance unit. A sheet discharge unit is arranged above the image forming unit and discharges the sheet on which the image was formed by the image forming unit. A discharge tray stacks and holds the sheet discharged by the sheet discharge unit. A reading unit is arranged above the discharge tray and reads the sheet. The discharge tray and the reading unit are pivotable in a same pivot direction.

### BACKGROUND

### Field of the Technology

The present disclosure relates to an image forming apparatus.

### Description of the Related Art

Some conventional image reading and forming apparatuses have a configuration in which an image reading apparatus is arranged above an image forming apparatus, and a conveyance roller conveys and discharges paper that has been subjected to printing by the image forming apparatus onto a discharge tray arranged between the image forming apparatus and the image reading apparatus. With such a configuration, in a case where the discharging has not been performed properly due to the occurrence of a paper jam during the conveying and discharging of the printed paper, a user pulls out and extracts the paper that has been conveyed partway from the conveyance roller, and at this time it is necessary to secure space necessary for the user to perform this task.

Japanese Patent Laid-Open No. 2005-306614 discloses a technique that enables a discharge tray to pivot on an image forming apparatus, thereby securing working space by pivoting the discharge tray when a paper jam occurs.

However, although a configuration of Japanese Patent Laid-Open No. 2005-306614 enables the discharge tray to pivot, it requires the image reading apparatus located above the discharge tray to be moved upward to secure working space for fixing a paper jam. However, when the relationship between the pivot direction for opening and closing the image reading apparatus and the pivot direction of the discharge tray is such that they are orthogonal to each other, if the image reading apparatus has pivoted a small amount, the discharge tray cannot pivot a large amount, and this gives rise to the problem that, in order to secure sufficient working space, the image reading apparatus needs to pivot a large amount, and the amount of space that is necessary for work increases.

### SUMMARY

An embodiment of the present disclosure provides an image reading and forming apparatus that realizes a further reduction in the amount of space required in maintenance of an image reading and forming apparatus.

According to the one embodiment of the present disclosure, an image forming apparatus comprises: a sheet conveyance unit configured to convey a sheet in a conveyance direction from a front surface side of a housing toward a rear surface side; an image forming unit configured to form an image on the sheet in the conveyance direction in the sheet conveyance unit; a sheet discharge unit that is arranged above the image forming unit and is configured to discharge the sheet on which the image was formed by the image forming unit; a discharge tray configured to stack and hold the sheet discharged by the sheet discharge unit; and a reading unit that is arranged above the discharge tray and is configured to read the sheet, wherein the discharge tray and the reading unit are pivotable in a same pivot direction.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A, 1B, 1C, 1D and 1E are perspective views of an image reading and forming apparatus according to the present embodiment.

FIG. 2A is a cross-sectional diagram of the image reading and forming apparatus in a case where an ADF unit according to the present embodiment is closed.

FIG. 2B is an enlarged cross-sectional diagram of the image reading and forming apparatus in a case where the ADF unit according to the present embodiment is closed.

FIG. 3A is a bird's-eye view of a scanner unit according to the present embodiment.

FIG. 3B is a cross-sectional diagram of the scanner unit according to the present embodiment.

FIG. 3C is a cross-sectional diagram of the scanner unit according to the present embodiment.

FIG. 4 is a diagram of a back surface of a glass frame unit according to the present embodiment.

FIG. 5 is a bird's-eye view showing an internal configuration of the image reading and forming apparatus according to the present embodiment.

FIG. 6 is a schematic cross-sectional diagram showing an internal configuration of the image reading and forming apparatus according to the present embodiment.

FIG. 7 is a partial perspective view showing an internal configuration of the image reading and forming apparatus according to the present embodiment.

FIG. 8A is a schematic cross-sectional diagram of a state where the scanner unit of the image reading and forming apparatus according to the present embodiment is closed.

FIG. 8B is a schematic cross-sectional diagram of a state where the scanner unit of the image reading and forming apparatus according to the present embodiment is open.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Regarding Overall Configuration of Image Reading and Forming Apparatus 1

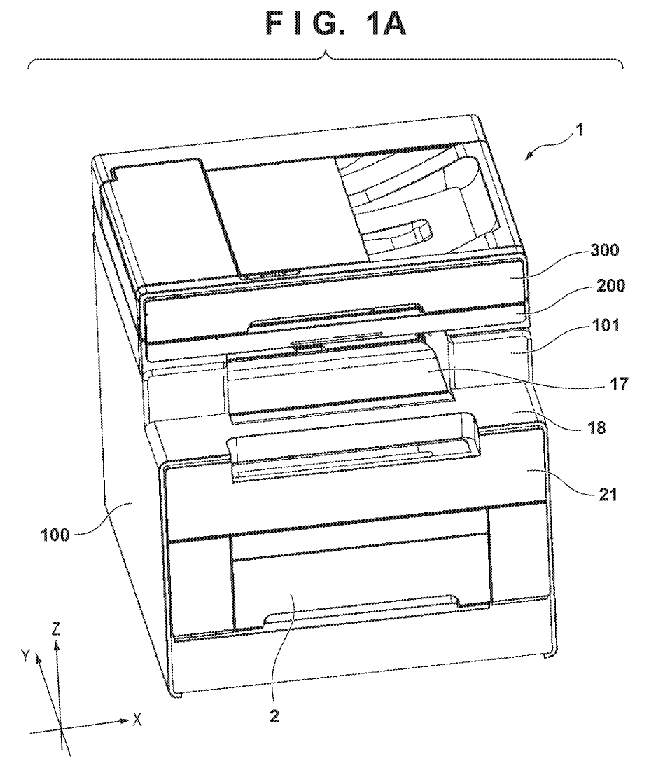

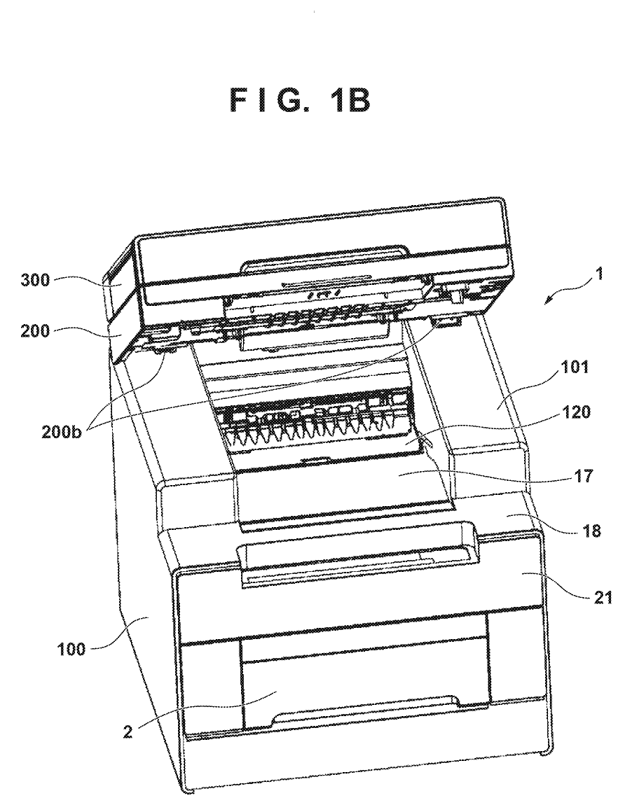

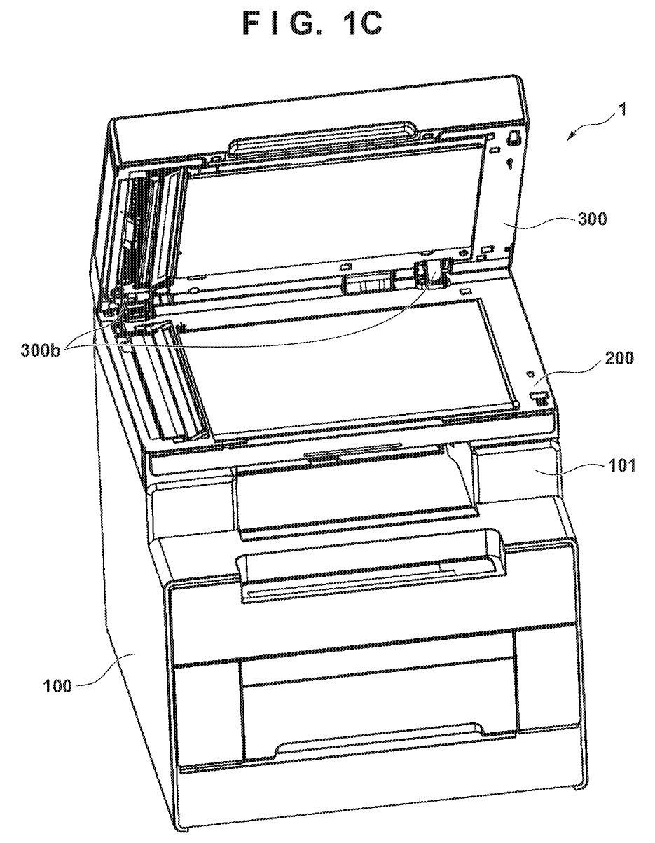

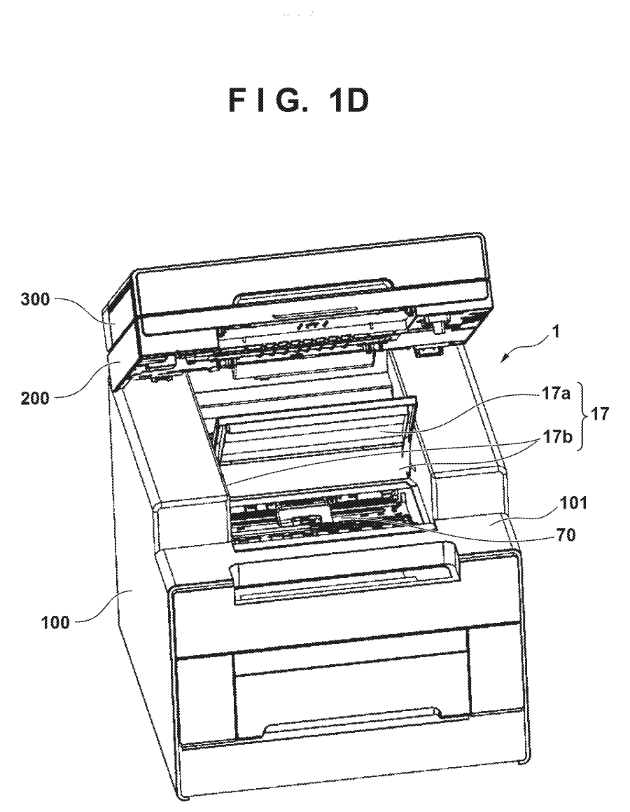

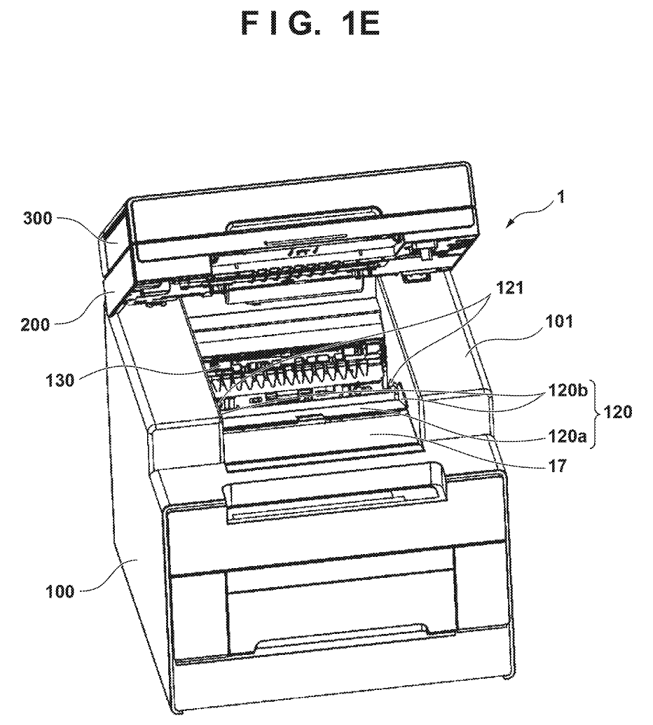

FIG. 1A is an overall perspective view of an image reading and forming apparatus 1 according to the present embodiment. The image reading and forming apparatus 1 according to the present embodiment is assumed to be an inkjet printer, and includes an image forming apparatus 100, a scanner unit 200, an ADF unit 300, a cassette 2, and a discharge tray 17. Note that although the image reading and forming apparatus 1 can also be referred to as an "image forming apparatus", it is assumed that the terms "image reading and forming apparatus 1" and "image forming apparatus 100" are each used here for distinction. The image forming apparatus 100 is demarcated by a housing 101. Also, the scanner unit 200, ADF unit 300, cassette 2, and discharge tray 17 are attached to the image forming apparatus 100. One or more sheets SH are stacked and accommodated in the cassette 2. It is sufficient that the sheets SH be sheet-like printing media, such as paper materials. For example, cut sheets of a size conforming to a predetermined standard (e.g., A4 size or the like) can be arbitrarily used as the sheets SH. The cassette 2 is a cassette that accommodates sheets on which printing is to be performed, and may be expressed here as a sheet cassette or an accommodation cassette, for example. Hereinafter, printing media including sheets may be referred to as "documents".

FIG. 1A shows coordinate axis directions (X, Y, and Z directions) that intersect with (are substantially orthogonal to) one another for ease of understanding of a structure. In the present embodiment, the X direction corresponds to the left-right direction (width direction) of the image reading and forming apparatus 1, the Y direction corresponds to the front-rear direction (depth direction) of the image reading and forming apparatus 1, and the Z direction corresponds to the up-down direction (height direction) of the image reading and forming apparatus 1. Note, it is assumed in FIG. 1A that, with respect to the image reading and forming apparatus 1, the −X side is the left side, the +X side is the right side, the −Y side is the front side, the +Y side is the rear side, the −Z side is the lower side, and the +Z side is the upper side. However, these axis directions are expressed simply as the X, Y, and Z directions when the distinction of ± is unnecessary in the following description. Also, both of the X and Y directions may be expressed as a horizontal direction, and the Z direction may be expressed as a vertical direction. The following description will be provided under the assumption that these coordinate axis directions are similarly set with respect to the image reading and forming apparatus 1 in the subsequent drawings. Furthermore, hereinafter, it is assumed that simple notations of "X direction", "Y direction", and "Z direction" refer to the aforementioned left-right direction, front-rear direction, and up-down direction of the image reading and forming apparatus 1, and vice versa.

FIG. 1B is an overall perspective view of the image reading and forming apparatus 1 in a state where the scanner unit 200 is open. The scanner unit 200 is an image reading unit that reads a document. The scanner unit 200 according to the present embodiment is attached to the image forming apparatus 100 via scanner hinge units 200b, and the scanner hinge units 200b enable the scanner unit 200 to pivot in a pivot direction around a pivot axis, which is the X direction.

The discharge tray 17 and a discharge tray 120 are located directly below the scanner unit 200. Provided that the side faced by an opening formed by a pivot movement of the scanner unit 200 is a product front surface side, an extended unit 18, which is a part of the image forming apparatus 100, is present at the product front surface side of the discharge tray 17. Also, the extended unit 18 is located at the product front surface side of the scanner unit 200 and the ADF unit 300. Here, the extended unit 18 extends from the discharge tray 17, and projects toward the product front surface side beyond an image reading unit of the scanner unit 200. A manual feed unit 21 and the cassette 2 are located directly below the extended unit 18. The manual feed unit 21 is pivotably retracted so that it opens in the product front surface direction, and enables manual feeding of sheets. The cassette 2 is retracted so as to be drawable in the product front surface direction. After sheets SH arranged in the manual feed unit 21 and the cassette 2 have been conveyed from the product front surface toward the +Y direction, which is the product rear surface direction, and printed, the conveyance direction is inverted, and the sheets SH are conveyed in the −Y direction; as a result, the printed and discharged sheets SH are loaded on the discharge tray 17 and the discharge tray 120. While the details will be described later, each of the discharge tray 17 and the discharge tray 120 is provided so as to seal the inside of the image forming apparatus 100 in an openable and closable manner; when they are in a closed state, the discharge tray 17 is located at the −Y side relative to the discharge tray 120.

FIG. 1C is an overall perspective view of the image reading and forming apparatus 1 in a state where the ADF unit 300 has pivoted and opened. The ADF unit 300 is an automatic document feeder that has a function of automatically conveying a document, and ADF hinge units 300b enable the ADF unit 300 to pivot in a pivot direction around a pivot axis, which is the X direction. The scanner unit 200 and the ADF unit 300 according to the present embodiment are connected via the ADF hinge units 300b. Also, while the details will be described later, the ADF unit 300 according to the present embodiment includes a discharged sheet stacking unit 320, and has a function of holding discharged sheets in a stacked manner.

In the present embodiment, the ADF unit 300 doubles as a cover for the image reading and forming apparatus 1, and a pivot movement of the ADF unit 300 causes the image reading unit of the scanner unit 200 to make a transition between an exposed state and a retracted state. It is assumed here that, regarding the image reading and forming apparatus 1, a side faced by an opening formed by a pivot movement of the ADF unit 300 (a surface at the −Y side) is referred to as a front surface, and a surface on the opposite side thereof (a surface at the +Y side) is referred to as a rear surface. The pivot axis of the scanner hinge units 200b according to the present embodiment is the X direction, and this pivot axis exists at the rear surface side of the center of the image reading and forming apparatus 1. It is assumed here that the expression "pivot axis exists at the rear surface side" denotes a state where the pivot axis exists (in this case, extends in the X direction) so as to pass only at the rear surface side of a boundary representing a plane that is the center between the front surface and the rear surface of the image reading and forming apparatus 1. Note that this is an expression for a case where the pivot axis is set by using the front surface and the rear surface as references, and a similar expression is possible with respect to other opposing surfaces.

The scanner unit 200 according to the present embodiment can pivot in the same pivot direction as the ADF unit 300 (the X-axis direction), as stated earlier. Also, the pivot axis of the ADF hinge units 300b, which are pivot units of the ADF unit 300 according to the present embodiment, is the X direction similarly to the scanner hinge units 200b, and this pivot axis exists at the rear surface side of the center of the image reading and forming apparatus 1. In this way, the discharge tray 17 and the scanner unit 200 of the image reading and forming apparatus 1 according to the present embodiment can pivot in the same pivot direction, and this pivot direction is the same as the pivot direction of a cover unit of the image reading and forming apparatus 1.

Note that although the following description will be provided under the assumption that the ADF unit 300 includes the discharged sheet stacking unit 320 (the ADF unit 300 and the discharged sheet stacking unit 320 are integrated), the ADF unit 300 and the discharged sheet stacking unit 320 may be mounted as separate constituents.

As shown in FIG. 1D, the discharge tray 17 includes a plate-like member 17a and shaft units 17b. The plate-like member 17a is pivotably supported by the shaft units 17b at its end portions on the +Y side. This configuration enables the discharge tray 17 to pivot in the pivot direction around a pivot axis, which is the X direction. Such pivoting of the discharge tray 17 can cause an opening 70 in an upper part of the image forming apparatus 100 to make a transition between an open state (see FIG. 1D) and a closed state (see FIG. 1B). Here, when the opening 70 is in the closed state (see FIG. 1B), the plate-like member 17a forms a substantially horizontal surface at the −Y side, and forms a sloped surface at the +Y side. This sloped surface is sloped so that it is lower at the +Y side, and higher at the −Y side.

As shown in FIG. 1E, the discharge tray 120 includes a plate-like member 120a and shaft units 120b. The shaft units 120b are mounted on both end portions (both lateral portions) of the plate-like member 120a in the X direction. Wall portions of the housing 101 that oppose the shaft units 120b are provided with guide rails 121 that extend along the sloped surface of the plate-like member 17a in the closed state, and the shaft units 120b slidably engage with the guide rails 121. This configuration enables the discharge tray 120 to slide to an upper part of the sloped surface of the discharge tray 17 in the closed state. Such sliding of the discharge tray 120 can cause an opening 130 in an upper part of the image forming apparatus 100 to make a transition between an open state (see FIG. 1E) and a closed state (see FIG. 1B).

Note that although the opening 70 and the opening 130 may be formed integrally in an upper part of the image forming apparatus 100, it is assumed here that a portion that is opened as a result of pivoting of the discharge tray 17 is the opening 70, and a portion that is opened as a result of sliding of the discharge tray 120 is the opening 130, for ease of understanding.

With the above-described configuration, a user can cause the inside of the image forming apparatus 100 to be in an opened state and exposed relatively easily by pivoting the discharge tray 17 or sliding the discharge tray 120. In this way, the user can visibly check the inside of the image forming apparatus 100 via the opening 70 or 130, and also access the inside of the image forming apparatus 100.

That is to say, the discharge tray 17 and the discharge tray 120 according to the present embodiment not only function as loading units on which discharged printed sheets SH are loaded, but also function as cover units that seal the inside of the image forming apparatus 100 in an openable and closable manner. Therefore, both of the discharge tray 17 and the discharge tray 120 may be expressed as discharge tray covers. Also, the discharge tray 17 and the discharge tray 120 may be expressed as a pivotable cover and a slidable cover, respectively, for distinction.

### Regarding Internal Structures of Scanner Unit 200 and ADF Unit 300

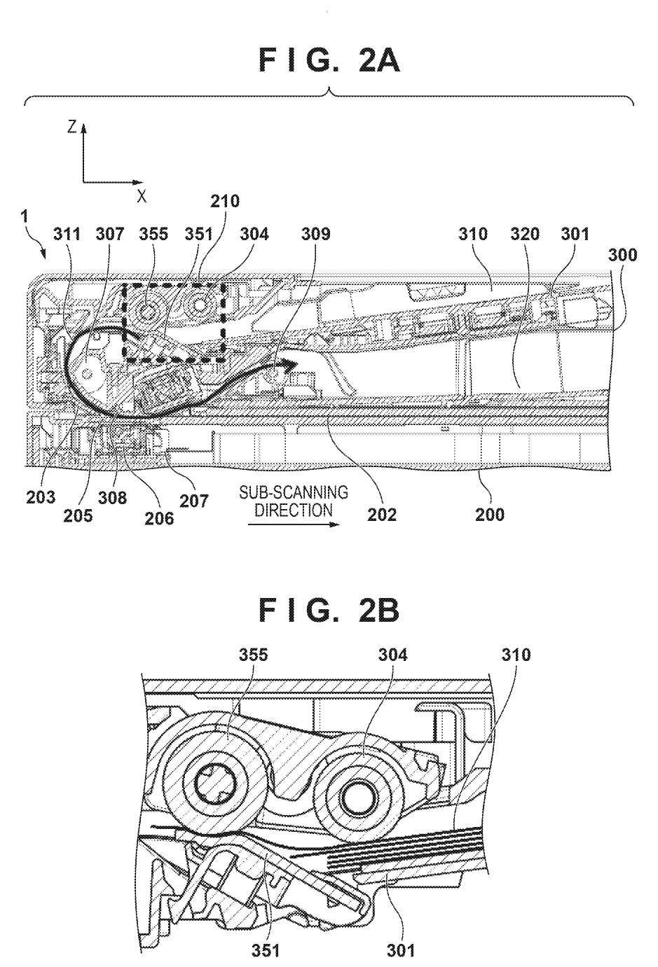

The following describes a configuration of the ADF unit 300 with use of FIGS. 2A and 2B. FIG. 2A is a cross-sectional diagram of the scanner unit 200 and the ADF unit 300 along an X–Z plane when the ADF unit 300 is closed. A configuration of a sheet conveyance path 311 (an arrow with a bold solid line) is indicated in the ADF unit 300 in FIG. 2A, and FIG. 2B is an enlarged view of a section indicated by a dash line 210 in FIG. 2A. Note that FIG. 2B is a diagram of a state where a later-described pickup roller 304 has been lowered to convey a sheet.

A part of the scanner unit 200 is used as a part of the sheet conveyance path 311. The ADF unit 300 includes a sheet loading board 301 on which a sheet is loaded, a sheet conveyance mechanism unit, and a discharged sheet stacking unit 320. Below, a configuration of the sheet conveyance mechanism unit will be described in order from the upstream side of sheet conveyance. Here, the sheet conveyance mechanism unit denotes an entirety of a sheet conveyance mechanism from the pickup roller 304 to a discharge roller 309, which will be described later. A conveyed sheet 310, which is placed on the sheet loading board 301 and automatically conveyed, is conveyed by the pickup roller 304 of the sheet conveyance mechanism unit toward a separation roller 355, and then conveyed to a conveyance roller 307 at the downstream side by being held between the separation roller 355 and a sheet separation unit 351. When the conveyed sheet 310 is held between the separation roller 355 and the sheet separation unit 351, a sheet that follows the conveyed sheet 310 stops as a result of coming into contact with the sheet separation unit 351 and receiving resistance. With this configuration, conveyed sheets 310 can be separated one by one when conveyed.

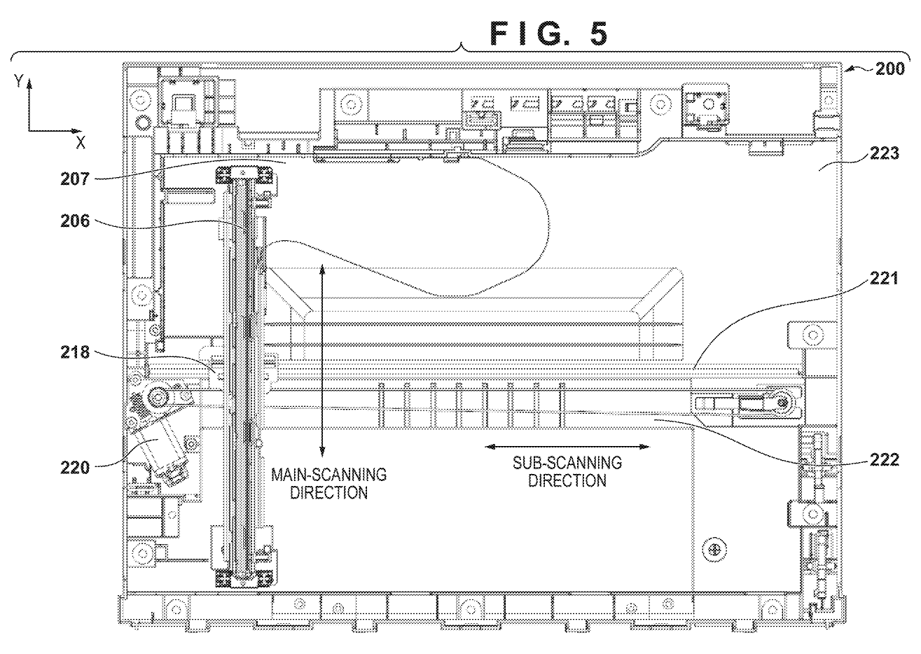

Next, the sheet is conveyed by the conveyance roller 307 to a conveyance guide 203 at the downstream side, and a white pressing plate 308 presses the sheet in close contact against an ADF glass 205. At this time, the sheet is read by an image sensor 206. Here, the white pressing plate 308 has a size that covers an entire region of the later-described image sensor 206, which is illustrated in FIG. 5, in the main-scanning direction. Various types of sheet detection sensors are disposed in the sheet conveyance mechanism unit, and passage of the leading edge and the trailing edge of the sheet are detected; an output signal corresponding to such detection is used in control on a timing of reading performed by the image sensor 206.

The image reading and forming apparatus 1 according to the present embodiment can use two types of sheet reading methods: a fixed-sheet reading method (flatbed reading), and a conveyed-sheet reading method (ADF reading). The fixed-sheet reading method is a reading method that reads the sheet by fixing the sheet on a sheet setting board glass 202 and causing a reading unit 207 to move in the sub-scanning direction (X direction). Also, the conveyed-sheet reading method is a method that performs reading while the sheet is conveyed by the ADF unit 300 with the reading unit 207 fixed at a predetermined position (an ADF position).

The reading unit 207 inside the scanner unit 200 of FIG. 2A is illustrated in a state where it is standing by at the ADF position so as to read the conveyed sheet 310, which is automatically conveyed, with use of the aforementioned ADF unit 300.

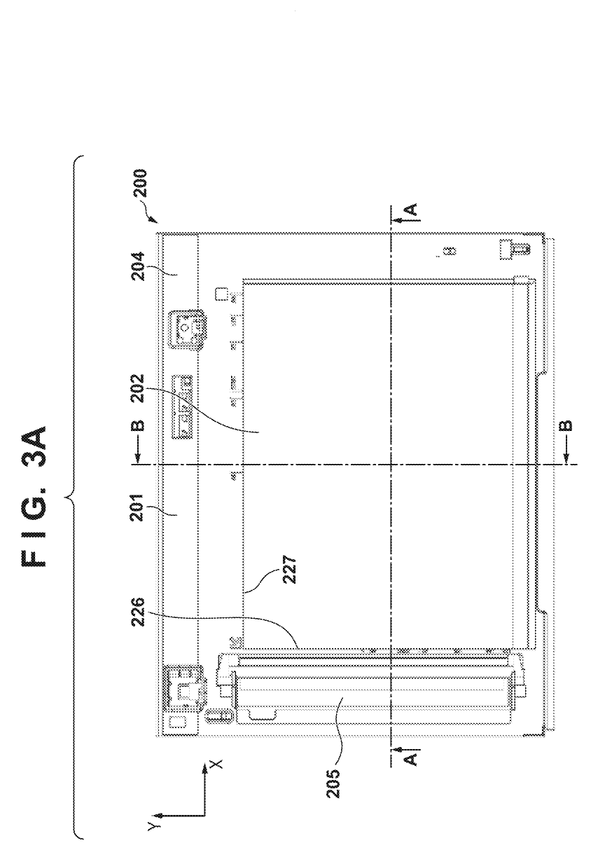

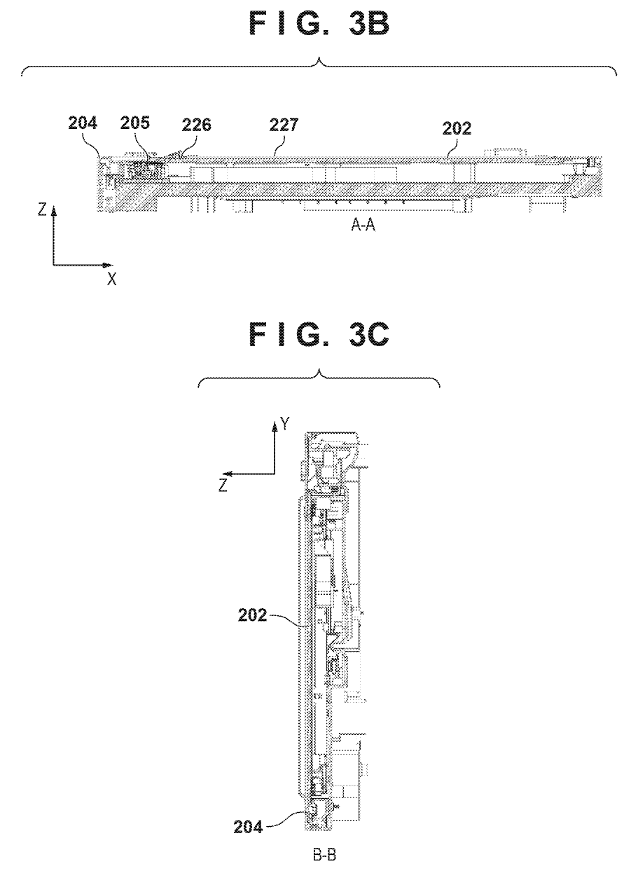

The following describes a configuration of the scanner unit 200 in the present embodiment with use of FIGS. 3A to 3C, FIG. 4, and FIG. 5. FIGS. 3A to 3C are diagrams showing the scanner unit 200 when the ADF unit 300 has been removed from the image reading and forming apparatus 1. FIG. 3A is a bird's-eye view of the scanner unit 200 when the ADF unit 300 has been removed from the image reading and forming apparatus 1, and shows an entirety of a glass frame unit 201. This glass frame unit 201 is composed of a glass frame 204 that holds the sheet setting board glass 202 on which a sheet is to be loaded, and the ADF glass 205 for reading the sheet that has been automatically conveyed. Also, the glass frame 204 includes an X-direction sheet abutting reference 226 and a Y-direction sheet abutting reference 227.

FIG. 3B shows an A–A cross-section of the scanner unit 200 shown in FIG. 3A. FIG. 3C shows a B–B cross-section of the scanner unit 200 shown in FIG. 3A, which is a cross-section of the scanner unit 200 in the main-scanning direction (Y direction). A later-described white sheet is arranged on the sheet loading surface side of the sheet setting board glass 202 in the figure.

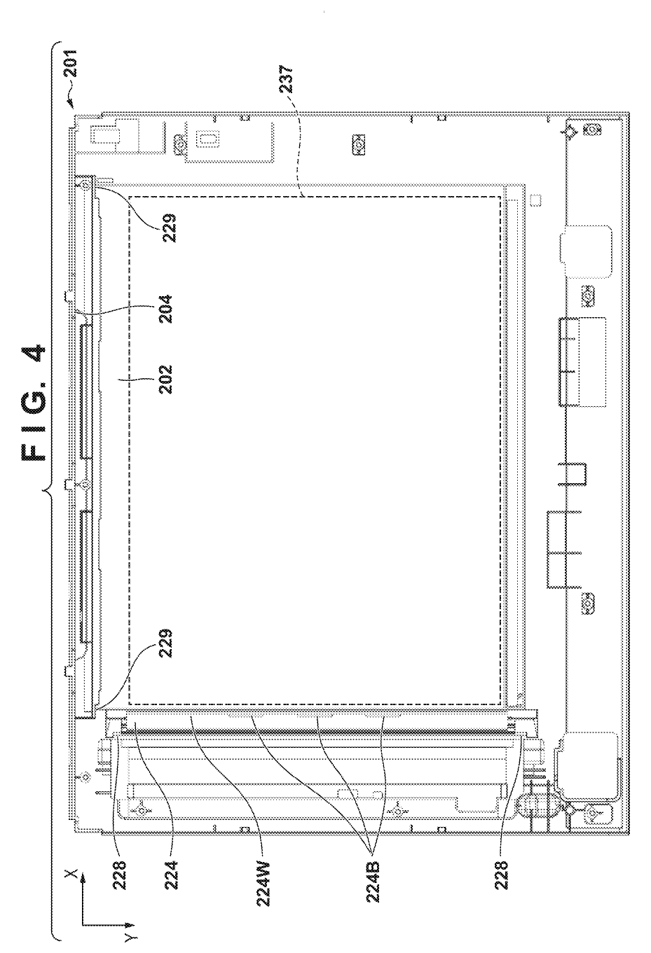

FIG. 4 is a diagram of a back surface of the glass frame unit 201 in FIG. 3A, and shows a part of a white sheet 224. The sheet setting board glass 202 abuts X-direction glass frame abutting units 228 of the glass frame 204 at two positions; as a result, the position thereof in the X direction is determined. Also, the sheet setting board glass 202 abuts Y-direction glass frame abutting units 229 of the glass frame 204 at two positions; as a result, the position thereof in the Y direction is determined. In the direction in which the present figure is viewed, the white sheet 224 is arranged at the rear surface side of the sheet setting board glass 202, which is the same surface as the sheet loading surface. In FIG. 4, the position of the white sheet 224 in the X direction is between the glass frame abutting units 228 and a stationary sheet reading area 237. Also, a white region 224W for making a shading correction for the image sensor, and black regions 224B that act as sub-scanning direction reference positions for the image sensor 206 shown in FIG. 5, are integrally included in the white sheet 224. The white sheet 224 according to the present embodiment has a size that covers an entire region of the image sensor 206 shown in FIG. 5 in the main-scanning direction. Inside the white sheet 224, the black regions 224B are formed so that the positions thereof in the sub-scanning direction (X direction) are closer to the stationary sheet reading area 237 than the white region 224W is.

FIG. 5 is a diagram showing a state where the glass frame unit has been removed from the bird's-eye view shown in FIG. 3A so as to show an entire internal configuration of the scanner unit 200. FIG. 5 shows the arrangements and configurations of the reading unit 207 and a base frame 223. A guide rail 221, whose longitudinal direction (X direction) is the sub-scanning direction, is arranged on a substantially central portion of the base frame 223 in the Y direction. A slider 218 of the reading unit 207 equipped with the image sensor 206 is arranged on the guide rail 221 so as to be slidable in the sub-scanning direction (X direction). When a driving input has been input to a motor 220, a belt 222 moves in accordance with this input, and the reading unit 207 can perform reciprocal scanning along the guide rail 221 via a driving transmission unit to which the belt 222 is connected.

Although the image reading and forming apparatus 1 according to the present embodiment is illustrated as a belt-driven type where a driving unit is arranged on the base frame 223 and a driving force thereof is transmitted via the belt, a reading unit of self-propelled type where the driving unit is arranged on the reading unit 207 may be used.

### Regarding Internal Structure of Image Forming Apparatus 100

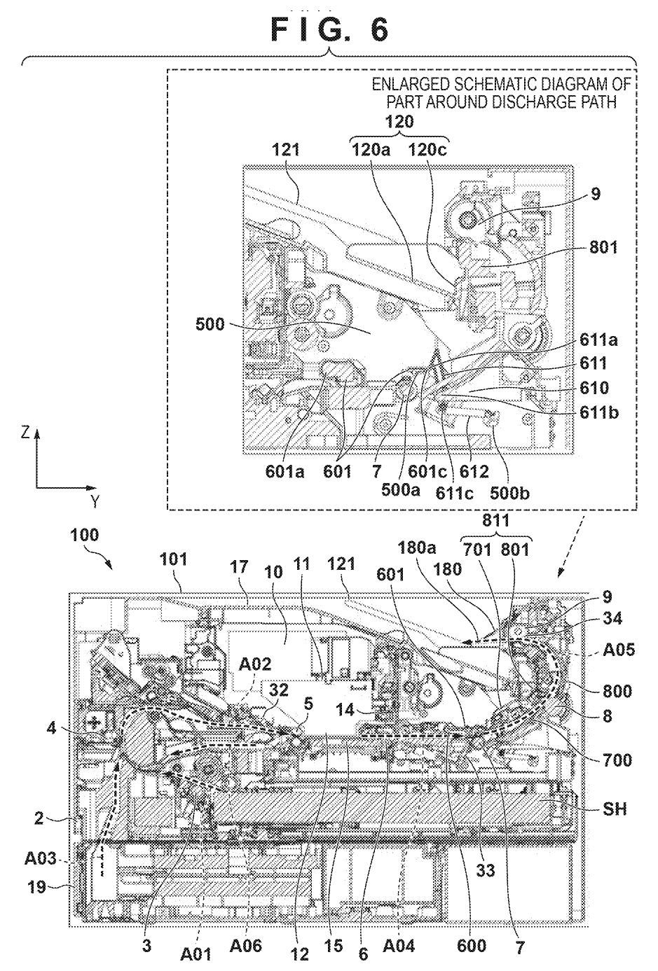

FIG. 6 is a schematic cross-sectional diagram showing an internal structure of the image forming apparatus 100. A printing unit 10, a driving unit 14, a platen 15, a plurality of conveyance units 3 to 9, a plurality of sensors 32 to 34, and a flapper 180 are provided inside the image forming apparatus 100.

The printing unit 10 includes a carriage 11 and a print head 12. The carriage 11 is configured in such a manner that it is equipped with the print head 12 and is reciprocally movable in the X direction; this enables the print head 12 to scan in the X direction. A plurality of nozzles are arrayed on a surface of the print head 12 opposing the platen 15, and each nozzle can eject ink that has been supplied from a non-illustrated ink tank via an ink tube.

The driving unit 14 drives the printing unit 10. As an example, the driving unit 14 includes a travelling belt for causing the carriage 11 to move reciprocally, a pulley for causing the travelling belt to travel, and an electric motor for driving the pulley. With this configuration, the driving unit 14 causes the print head 12 to scan by making the carriage 11 move reciprocally while a sheet SH is passing between the print head 12 and the platen 15, and causes each nozzle to eject ink by driving the print head 12 during this scanning. In this way, an image is formed on the sheet SH.

Printing according to the present embodiment denotes formation of an image through ejection of ink onto the sheet SH. Here, the concept of "image" includes characters, numerals, signs, shapes, photographs, and so forth, and there are no restrictions regarding whether they can be visibly checked. Although the ink can be a liquid including a dye or a pigment, it may be a colorless and transparent reaction liquid, and they may be inclusively expressed as a liquid. In view of this, the image reading and forming apparatus 1 may be expressed as a liquid ejection apparatus, and the print head 12 may be expressed as a liquid ejection head.

In the present embodiment, printing on the sheet SH is realized by alternatingly performing an operation of conveying the sheet SH by a predetermined distance and then suppressing this conveyance (intermittent conveyance), and an operation of performing printing through scanning of the print head 12 while this conveyance is suppressed (print scanning). Such a print head 12 is also referred to as a serial head. In another working example, the print head 12 may be a line head that enables printing across an entire region of the sheet SH in the width direction at a time.

Each of the conveyance units 3 to 9 is placed at their corresponding positions along the conveyance path of the sheet SH illustrated by an arrow with a dash line. Driving rollers and driven rollers, or driven spurs, rotate together while holding the sheet SH therebetween; as a result, the sheet SH is conveyed. The driven rollers are placed at the side of the surface of the pre-printing sheet SH on which printing should be performed, while the driven spurs are placed at the side of the surface of the post-printing sheet SH on which printing has been performed. Each of the driven rollers and the driven spurs is rotatably placed in such a manner that it is pushed by a non-illustrated pushing unit against the corresponding driving roller so as to come into contact with the driving roller. Note that the driven spurs may be other disk-shaped rotating members.

The conveyance unit 3 includes driving rollers and driven rollers that are in contact with each other, and conveys the sheet SH that has been picked up from the cassette 2 (see an arrow A01). Meanwhile, the conveyance unit 4 includes driving rollers and driven rollers that are in contact with each other, similarly to the conveyance unit 3, and further conveys the sheet SH conveyed from the conveyance unit 3 (see an arrow A02). Note that the conveyance unit 4 can also receive and convey the sheet SH from an external feed unit 19 that has been additionally attached to a lower part of the image forming apparatus 100 (see an arrow A03).

The conveyance units 5 and 6 can execute the intermittent conveyance, and can also execute conveyance at a constant speed. The conveyance unit 5 is placed upstream relative to the printing unit 10 in the conveyance direction, includes driving rollers and driven rollers that are in contact with each other, and performs intermittent conveyance of the sheet SH toward the printing unit 10. Meanwhile, the conveyance unit 6 is placed downstream relative to the printing unit 10 in the conveyance direction, includes driving rollers and driven rollers that are in contact with each other, and performs intermittent conveyance of the sheet SH that has already been printed by the printing unit 10 further downstream (see an arrow A04).

Each of the conveyance units 7 to 9 includes driving rollers and driven rollers that are in contact with each other. The conveyance units 7 to 9 are placed along a discharge path (or a discharge conveyance path) for discharging the printed sheet SH conveyed from the conveyance unit 6. That is to say, the discharge path of the sheet SH according to the present embodiment denotes a path via which the sheet SH can pass from the conveyance unit 6 to the conveyance unit 9 among the conveyance paths of the sheet SH illustrated by the arrow A01 and the like. So as to pass through a rear part inside the image forming apparatus 100, this discharge path is formed in such a manner that it is curved from a lower rear part to an upper rear part (see an arrow A05). The sheet SH is discharged onto the discharge trays 17 and 120 in an inverted state where the printed surface thereof faces down. Such a discharge mode can be referred to as face-down discharge. In the present embodiment, the respective positions of the conveyance units 7 to 9 on the aforementioned curved discharge path are distinguished from one another, under the assumption that the conveyance unit 7 is at the lowermost position, the conveyance unit 8 is at the rearmost position, and the conveyance unit 9 is at the uppermost position.

In the conveyance units 6 to 9 that are placed at the downstream side of the printing unit 10, the driven spurs are placed at the side of the printed surface of the sheet SH, and the driving rollers are placed at the opposite side.

Note that the aforementioned conveyance units 3 to 9 may be expressed by other names depending on the purpose, intended use, arrangement position, and so forth, for the sake of distinction from one another. For example, the conveyance units 3 and 4 may be expressed as feed units, and the conveyance units 7 to 9 may be expressed as discharge units.

The sensors 32 to 34 are configured to be capable of detecting whether the sheet SH exists. For example, the sensors 32 to 34 can detect passage of the leading edge (the edge on the downstream side) and the trailing edge (the edge on the upstream side) of the sheet SH. For example, a known optical sensor can be arbitrarily adopted as each of the sensors 32 to 34. The sensor 32 is placed at the upstream side of the printing unit 10, and at the upstream side of the conveyance unit 5 in the present example. The sensor 33 is placed at the downstream side of the printing unit 10, and at the downstream side of the conveyance unit 6 and in the vicinity of the conveyance unit 7 in the present example. The sensor 34 is placed at the downstream side of the aforementioned curved discharge path, and in the vicinity of the conveyance unit 9 in the present example. In this way, the position of the sheet SH to be conveyed can be specified.

A guide unit 601 that guides the printed surface of the sheet SH and a guide unit 600 that guides the surface of the sheet SH on the opposite side are placed between the conveyance units 6 and 7 so as to oppose each other. Similarly, a guide unit 701 and a guide unit 700 are placed between the conveyance units 7 and 8 so as to oppose each other. Furthermore, a guide unit 801 and a guide unit 800 are placed between the conveyance units 8 and 9 so as to oppose each other. A guide mechanism, which includes these guide units 600, 601, 700, 701, 800, and 801, forms the aforementioned curved discharge path, and may be collectively referred to as a discharge guide mechanism.

Note that although the present description has been provided under the assumption that the image forming apparatus 100 performs printing only on one surface of the sheet SH, it may be capable of performing printing on the printed surface of the sheet SH and the surface thereof on the opposite side (capable of performing so-called double-sided printing). In a case where double-sided printing is performed, the sheet SH for which printing has been performed only on one surface is first conveyed halfway through the aforementioned curved discharge path; thereafter, the conveyance units 5 to 9 cause the sheet SH to pass through the printing unit 10 and return to the conveyance unit 4 in which the front and the back of the sheet SH are inverted (see an arrow A06). Thereafter, the sheet SH is conveyed to the printing unit 10 again, a series of printing processing is executed therefor, and printing on both surfaces is completed.

In view of this, assuming that the surface of the sheet SH on which printing was performed last is the front surface and the surface thereof on the opposite side is the back surface, the guide unit 601 and the guide unit 600 may be expressed as a front surface guide unit and a back surface guide unit, respectively, to be distinguished from each other. Also, the guide unit 601 and the guide unit 600 may be expressed as a one surface guide unit (or other surface guide unit) and another surface guide unit (or one surface guide unit), respectively, to be distinguished from each other. Furthermore, based on an internal structure that forms the aforementioned curved discharge path, the guide unit 601 and the guide unit 600 may be expressed as an inner circumferential side guide unit and an outer circumferential side guide unit, respectively, to be distinguished from each other. Similar expressions are possible also with regard to the guide units 700 and 701, and the guide units 800 and 801. Note that in a case where printing is not performed on the other surface after printing has been performed on one surface and the front and back have been inverted, the surface that opposes the printing unit 10 may be regarded as the front surface, and the surface on the opposite side thereof may be regarded as the back surface.

In the following description, it is assumed that each of the guide units 601, 701, and 801 is expressed as the front surface guide unit, and each of the guide units 600, 700, and 800 is expressed as the back surface guide unit, for distinction.

The front surface guide unit 601 is pivotably arranged inside the image forming apparatus 100. Also, the front surface guide units 701 and 801 are unitized as a downstream side front surface guide unit 811, and are pivotably arranged inside the image forming apparatus 100.

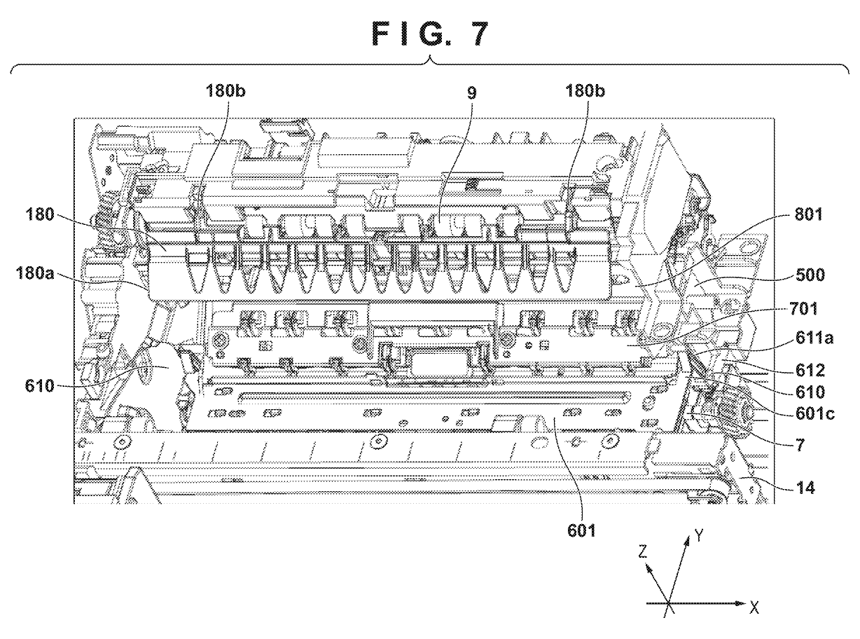

The flapper 180 is arranged in a rear portion of an upper part of the image forming apparatus 100 so as to be pivotable around shaft units 180b (see FIG. 7), which act as a pivot axis. The flapper 180 according to the present embodiment is pushed by a non-illustrated pushing unit so that a front end portion 180a of the flapper 180 is oriented to face the discharge trays 17 and 120. Consequently, the printed sheet SH discharged to the outside of the image forming apparatus 100 is appropriately loaded on the discharge tray 17 and the discharge tray 120; in a case where two or more sheets SH are discharged, they are stacked on the discharge tray 17 and the discharge tray 120.

As described above, in the image reading and forming apparatus 1 according to the present embodiment, the discharge direction of the conveyed sheet SH is the direction from the rear surface to the front surface of the image reading and forming apparatus 1. Here, it is assumed that the angle of a sheet discharge unit is not limited in particular, and can be arbitrarily set so that it is orthogonal to the direction of the pivot axis of the scanner hinge units 200b (the X-axis direction).

Note that the flapper 180 may be provided with a non-illustrated sensor so as to monitor the height (angle) of the front end portion 180a. It is assumed here that, in a case where the height of the front end portion 180a has become higher than a predetermined reference (which can be arbitrarily set), the amount of sheets SH stacked on the discharge trays 17 and 120 is considered to have become equal to or larger than a reference, a predetermined notification is provided, and a printing operation is suspended additionally.

With the above-described configuration, printing is performed with respect to a sheet SH conveyed by the conveyance units 3 and 4 through the intermittent conveyance in the conveyance units 5 and 6 and the print scanning in the print head 12. Then, the conveyance units 6 to 9 discharge the printed sheet SH to the outside of the image forming apparatus 100, and load the printed sheet SH on the discharge trays 17 and 120.

FIG. 7 is a partial perspective view showing a detailed structure of a part around the discharge path shown in FIG. 6. Parts of the aforementioned elements of the image reading and forming apparatus 1 are fixed directly or indirectly to an inner side wall 500 of the housing 101, and parts of other elements are pivotable with respect to the inner side wall 500. For example, in the present embodiment, the front surface guide unit 601 is pivotable around a shaft unit 601a, which acts as a pivot axis.

A positioning unit 500a and a fixed unit 500b are provided on the inner side wall 500, and a lock mechanism 610 for locking the front surface guide unit 601 is attached to the inner side wall 500. The lock mechanism 610 includes a lever unit 611 and a pushing unit 612. The lever unit 611 includes a hook unit 611a, a pivot shaft 611b, and a fixed unit 611c. According to the present embodiment, the pivot shaft 611b enables the lever unit 611 to pivot between the hook unit 611a and the fixed unit 611c. The pushing unit 612 is provided so as to extend between the fixed units 500b and 611c. The pushing unit 612 according to the present embodiment pushes the lever unit 611 so that the hook unit 611a is locked on a lock unit 601c. In this way, the lever unit 611 pushed by the pushing unit 612 causes the front surface guide unit 601 to be locked at the positioning unit 500a. The foregoing configuration is provided on both sides of the housing 101 in the X direction.

### Advantageous Effects in Maintenance

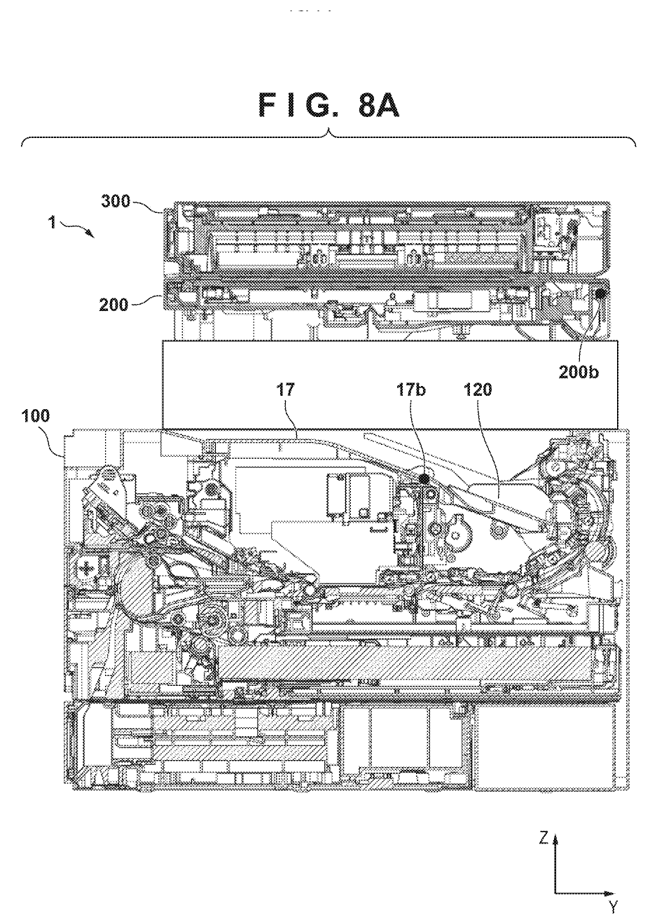

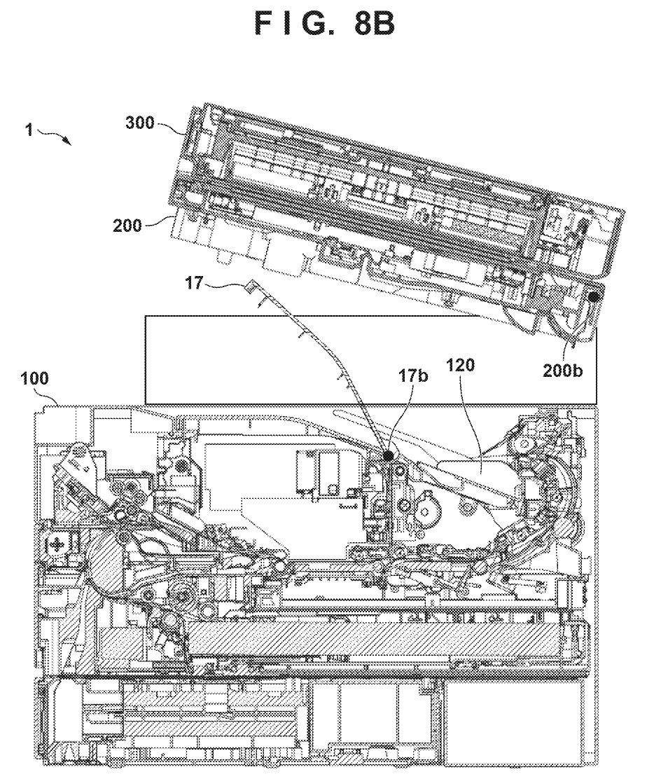

FIG. 8A shows a cross-sectional diagram of a state where the scanner unit 200 is closed in the image reading and forming apparatus 1. Also, FIG. 8B shows a cross-sectional diagram of a state where the scanner unit 200 is open. As stated earlier, the user can place the inside of the image forming apparatus 100 in an opened state and access the inside of the image forming apparatus 100 by pivoting the discharge tray 17 or sliding the discharge tray 120. Therefore, in a case where a jam (paper jam) has occurred during the conveyance of a sheet SH, the user can access the inside of the image reading and forming apparatus 1 and remove the sheet in the jammed state (hereinafter, jammed sheet) SH by pivoting the discharge tray 17 or sliding the discharge tray 120.

According to the aforementioned configuration of the image reading and forming apparatus, the scanner unit 200 is located directly above the discharge tray 17; therefore, in order to remove the jammed sheet, it is necessary to move the scanner unit 200 upward by pivoting the scanner unit 200 as shown in FIG. 8B, and then pivot the discharge tray 17 to secure a maintenance space for removing the jammed sheet. In the image reading and forming apparatus 1 according to the present embodiment, the pivot axis (shaft units 17b) of the discharge tray 17 and the pivot axis (scanner hinge units 200b) of the scanner unit 200 are both arranged along the same pivot direction (X-axis direction), their pivot directions are the same when they open, and a maintenance space can be secured by a small pivot amount; therefore, there is no need to broadly pivot the scanner unit 200 for maintenance, and the space used by the product at the time of maintenance can be reduced. This enables the user to use the product in a smaller space, even during the maintenance.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-026025, filed February 20, 2025, and No.2025-209599, filed November 28, 2025 which are hereby incorporated by reference herein in their entirety.

What is claimed is:

1. An image forming apparatus comprising:
a sheet conveyance unit configured to convey a sheet in a conveyance direction from a front surface side of a housing toward a rear surface side;
an image forming unit configured to form an image on the sheet in the conveyance direction in the sheet conveyance unit;
a sheet discharge unit that is arranged above the image forming unit and is configured to discharge the sheet on which the image was formed by the image forming unit;
a discharge tray configured to stack and hold the sheet discharged by the sheet discharge unit; and
a reading unit that is arranged above the discharge tray and is configured to read the sheet,
wherein the discharge tray and the reading unit are pivotable in a same pivot direction.

2. The image forming apparatus according to claim 1, further comprising
a cassette in which the sheet is stackable,
wherein the sheet is conveyed from the cassette toward the front surface side and then the sheet is conveyed in the conveyance direction in the sheet conveyance unit.

3. The image forming apparatus according to claim 1, wherein
in a case where images are to be formed on both surfaces of the sheet, the sheet is conveyed toward the front surface side after an image is formed on one surface.

4. The image forming apparatus according to claim 1, further comprising
an extended unit that extends from the discharge tray and projects toward the front surface side beyond the reading unit.

5. The image forming apparatus according to claim 1, further comprising
a manual feed unit that is provided on the front surface and is configured to enable performing manual feeding of a sheet.

6. The image forming apparatus according to claim 1, further comprising
a cover unit configured to cause an image reading unit, which is configured to read a sheet, of the reading unit to transition between an exposed state and a retracted state through a pivot movement,
wherein the front surface is a surface faced by an opening formed by a pivot movement of the cover unit,
a pivot axis of the discharge tray and a pivot axis of the reading unit extend in a same direction as a pivot axis in the pivot movement of the cover unit, and
the pivot axis of the discharge tray and the pivot axis of the reading unit exist on a rear surface side of a center between the front surface and the rear surface.

7. The image forming apparatus according to claim 1, further comprising
a cover unit configured to cause an image reading unit, which is configured to read a sheet, of the reading unit to transition between an exposed state and a retracted state through a pivot movement,
wherein the front surface is a surface faced by an opening formed by a pivot movement of the cover unit, and
letting the rear surface be a surface opposite to the front surface, a discharge direction in which the sheet is discharged by the sheet discharge unit is a direction from the rear surface toward the front surface.

8. The image forming apparatus according to claim 1, wherein
a discharge direction in which the sheet is discharged by the sheet discharge unit is orthogonal to a direction of a pivot axis of a pivot movement of the reading unit.

9. The image forming apparatus according to claim 1, wherein
the image forming unit is an ejection head that ejects a liquid onto the sheet.
